(19) United States
(12) Patent Application Publication
(10) Pub. No.: US 2026/0277516 A1
(43) Pub. Date: Sep. 17, 2026

(54) NETWORK DEVICE, METHOD, AND STORAGE MEDIUM

(71) Applicant: CANON KABUSHIKI KAISHA, Tokyo (JP)

(72) Inventor: Takuma Hirose, Kanagawa (JP)

(21) Appl. No.: 19/539,305

(22) Filed: Feb. 13, 2026

(30) Foreign Application Priority Data
Mar. 14, 2025 (JP) 2025-041322

(51) Int. Cl. G06F 3/12

(52) U.S. Cl. CPC G06F 3/1285; G06F 3/1204; G06F 3/1297

(57) ABSTRACT

A network device that is provided with a display unit and is capable of providing a remote user interface to a user terminal via a web server displays, on the display unit, a display screen provided by a dashboard for providing at least one of information indicating a security countermeasure status of the network device itself, information related to troubleshooting of the network device itself, and information related to environmental load, stores a setting indicating that the information provided by the dashboard is also to be provided by software using a Progressive Web App, and, in accordance with the setting, outputs, to the user terminal on which the software using the Progressive Web App has been installed via the remote user interface, data including the information provided by the dashboard.

### BACKGROUND

### Field of the Technology

The present disclosure relates to a network device, a method, and a storage medium.

### Description of the Related Art

Technology exists for displaying information related to network devices such as image processing apparatuses. Technology also exists for causing information displayed on a network device to be displayed on equipment different from the network device. Japanese Patent Laid-Open No. 2023-139685 discloses a system that improves an input operation by an operation panel of the device by displaying an operation screen on the operation panel of the device on a mobile terminal screen of a device user via a network, and transmitting an operation on the mobile terminal to the device.

In this context, in order to cause a user to confirm a state of a network device, there are cases in which state information with respect to a state of the network device is displayed. In this case, in a case in which the state information is displayed only on the network device, since it is necessary for the user to move to a location at which the network device is provided in order to confirm the state information, there are cases in which a burden on the user in confirming the state information becomes large.

### SUMMARY

The present disclosure is directed to reduce a burden on a user in confirmation of information with respect to a state of a network device as compared to a configuration in which the information with respect to the state of the network device is displayed only on the network device.

A network device according to an aspect of the present disclosure that is provided with a display unit and is capable of providing a remote user interface to a user terminal via a web server displays, on the display unit, a display screen provided by a dashboard for providing at least one of information indicating a security countermeasure status of the network device itself, information related to troubleshooting of the network device itself, and information related to environmental load, stores a setting indicating that the information provided by the dashboard is also to be provided by software using a Progressive Web App, and, in accordance with the setting, outputs, to the user terminal on which the software using the Progressive Web App has been installed via the remote user interface, data including the information provided by the dashboard.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a management system according to a First Embodiment.

FIG. 2A is a block diagram showing a hardware configuration of an information terminal, and FIG. 2B is a block diagram showing a hardware configuration of a printer.

FIG. 3 is a diagram showing a functional configuration of a printer and a functional configuration of an information terminal.

FIG. 4 is a diagram showing a state monitoring screen.

FIG. 5 is a sequence diagram showing a flow from when a printer specifies a state until information indicating the specified state is displayed on an information terminal.

FIG. 6 is a flowchart diagram showing a flow of transmission processing.

FIG. 7 is a diagram showing a state screen.

FIG. 8 is a diagram showing a state screen.

FIG. 9 is a diagram showing a printer information screen.

FIG. 10 is a diagram showing a setting screen.

FIG. 11 is an overall configuration diagram of a management system according to a Second Embodiment.

FIG. 12 is a hardware configuration diagram of a push server.

FIG. 13 is a diagram showing a functional configuration of a printer and a functional configuration of a push server.

FIG. 14 is a diagram showing a setting screen.

FIG. 15 is a diagram showing a notification screen.

### DESCRIPTION OF THE EMBODIMENTS

### First Embodiment

Hereinafter, an embodiment of the present disclosure will be explained with reference to the drawings.

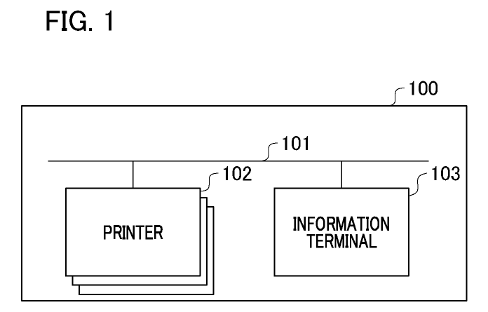

FIG. 1 is an overall configuration diagram of a management system 100. The management system 100 is a system that manages a network device by managing information with respect to a network device that is equipment capable of communication. Information that is a target of management by the management system 100 includes, for example, information with respect to a state of the network device, and the like. In addition, examples of the network device include an image processing apparatus such as a multifunction peripheral (MFP), and the like. However, equipment serving as the network device may be equipment different from the image processing apparatus, such as a network router, a surveillance camera, digital medical equipment, an automobile, a delivery box, a locker, and the like.

In the present embodiment, the management system 100 includes a printer 102 and an information terminal 103. The printer 102 and the information terminal 103 are connected via a network 101.

The printer 102 serving as an example of the network device has functions such as printing. The printer 102, by using a web server function (not shown) that the printer 102 has, provides, to the information terminal 103, a function capable of performing confirmation of a state of the printer 102 and the like. This function is called a remote user interface (hereinafter, referred to as remote UI).

It should be noted that a mechanism of information provision via the network 101 from the printer 102 in the present embodiment is realized by using Progressive Web App (hereinafter, PWA) in addition to the remote UI and the like. PWA is a technology in which a web application related to a website can be used as if the web application were an application operating on the information terminal 103. PWA is application software that is constructed by using general web technology such as HTML, CSS, JavaScript, and Web Assembly, and is downloadable and installable via a web browser (hereinafter, referred to as a browser). In addition, in PWA, there is no need for a user to download the PWA from, for example, an application store provided on the Internet that is deployed by a vendor providing an operating system (OS), and install the PWA on the information terminal 103. For example, if a website supports PWA, the user accesses the website using the browser of the information terminal 103, and can use the PWA by downloading the PWA. A provider of the website can also freely design content of the PWA. In addition, in PWA, by utilizing a function of a Service Worker, push notification to the information terminal 103, display of an icon on a home screen, and the like from an application server that is constructed by a provider of the website or the like are also realizable. This push notification is realized via a push server that is prepared by a vendor of the browser or the like, and in that case, a predetermined API that is supported by the OS or the browser of the information terminal 103 is used. It should be noted that a Service Worker is a script that operates as a background process. In the present embodiment, the information terminal 103 uses the browser, and is capable of installing the PWA dedicated to the printer 102 by accessing the remote UI.

The information terminal 103 serving as an example of a user terminal is a terminal apparatus owned by a user who is an administrator of the printer 102. A predetermined OS (not shown) and a browser are installed on the information terminal 103, and by a user inputting an IP address of the printer 102 into the browser, and the like, the information terminal 103 connects to the URL of the remote UI by using the browser. In addition, the information terminal 103 installs a PWA corresponding to a website that is connected to via the browser. Then, the information terminal 103 enables the user to confirm information related to the printer 102 by displaying information acquired from the printer 102. An example of the information terminal 103 is a computer apparatus such as a PC, a smartphone, a tablet terminal, and the like.

The type of the network 101 is not particularly limited provided that transmission and reception of data are possible. The network 101 includes, for example, the Internet, a LAN (Local Area Network), a WAN (Wide Area Network), a telephone line, a dedicated digital line, an ATM line or a frame relay line, a cable television line, a wireless line for data broadcasting, and the like. In addition, a communication line used for transmission and reception of data may be wired or wireless.

It should be noted that the number of printers 102 provided in the management system 100 may be any number.

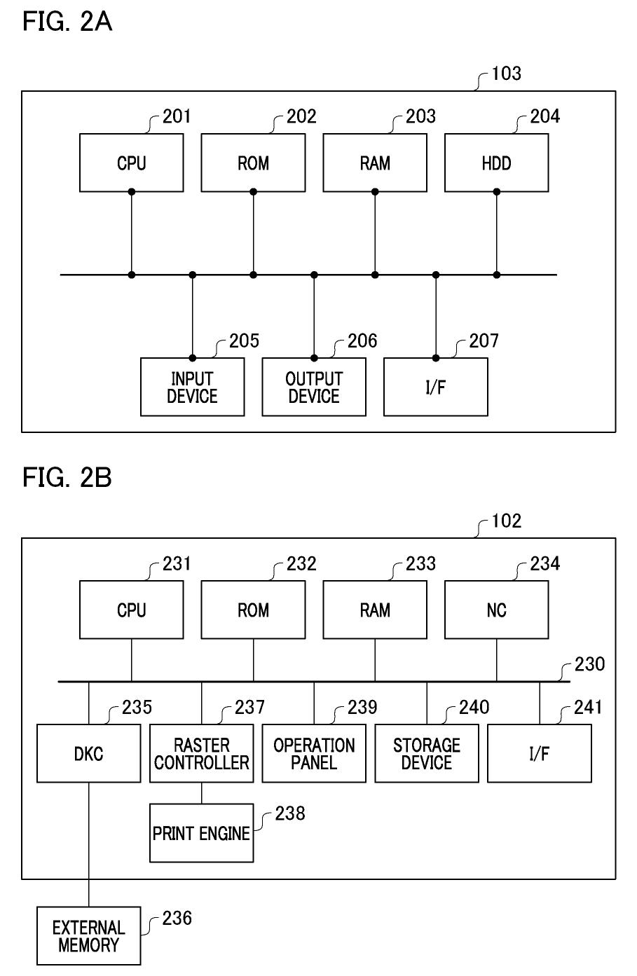

FIG. 2A is a block diagram showing the hardware configuration of the information terminal 103.

The information terminal 103 includes a central processing unit (CPU) 201, a read-only memory (ROM) 202, a random access memory (RAM) 203, a hard disk drive (HDD) 204, an input device 205, an output device 206, and an interface (I/F) 207. The CPU 201, the ROM 202, the RAM 203, the HDD 204, the input device 205, the output device 206, and the I/F 207 are each connected via an internal bus.

The CPU 201 controls the entirety of the information terminal 103. The ROM 202 stores a BIOS. The RAM 203 is used for a work area of the CPU 201 and temporary storage for loading a software module for realizing the present disclosure. The HDD 204 is an indirect storage device in which an OS that is basic software and a software module are stored. It should be noted that an SSD (Solid State Drive) may be used instead of the HDD 204. The input device 205 is a device, such as a keyboard, a pointing device, and the like, used for input of information. The output device 206 is a device, such as a display, a speaker, and the like, used for output of information. The I/F 207 is an interface for connecting to the network 101.

In the information terminal 103, after startup, the BIOS is executed by the CPU 201, and the OS is loaded from the HDD 204 to the RAM 203 to be executable. The CPU 201, in accordance with operation of the OS, loads various software modules described later from the HDD 204 to the RAM 203 at any time to be executable. In addition, various software modules of the information terminal 103 are executed by the CPU 201 and operate.

FIG. 2B is a hardware configuration diagram of the printer 102.

The printer 102 includes a CPU 231, a ROM 232, a RAM 233, a network controller (NC) 234, a disk controller (DKC) 235, a raster controller 237, a print engine 238, an operation panel 239, a storage device 240, and an I/F 241. The CPU 231, the ROM 232, the RAM 233, the NC 234, the DKC 235, the raster controller 237, the print engine 238, the operation panel 239, the storage device 240, and the I/F 241 are each connected via a system bus 230.

The CPU 231 controls the entirety of the printer 102 by controlling each component connected to the system bus 230. The CPU 231 performs the above-described control based on a control program stored in the ROM 232, a control program stored in an external memory 236 connected via the DKC 235, resource data (resource information), and the like. The RAM 233 functions as a main memory, a work area, and the like of the CPU 231, and is configured so that memory capacity can be expanded by an optional RAM connected to an expansion port (not shown). The storage device 240 is an external storage unit that functions as a large-capacity memory. The operation panel 239 displays a screen and receives an operation instruction of a user via the screen. In addition, the operation panel 239 displays settings of an operation mode of the printer 102 and the like, and information of an operation status of the printer 102, content data to be printed, and the like. An example of the operation panel 239 is a touch panel. The NC 234 is, for example, a network interface card (NIC), and transmits and receives information to and from an external apparatus. The raster controller 237 is a controller that converts print data described in, for example, a PDL language into image data. The print engine 238 uses known printing technology, and forms an image on a sheet based on image data input from the raster controller 237. Examples of the print engine 238 include a print engine of an electrophotographic method (laser beam method), an inkjet method, a sublimation (thermal transfer) method, and the like. The I/F 241 is a connection interface to an external device connectable by USB and the like.

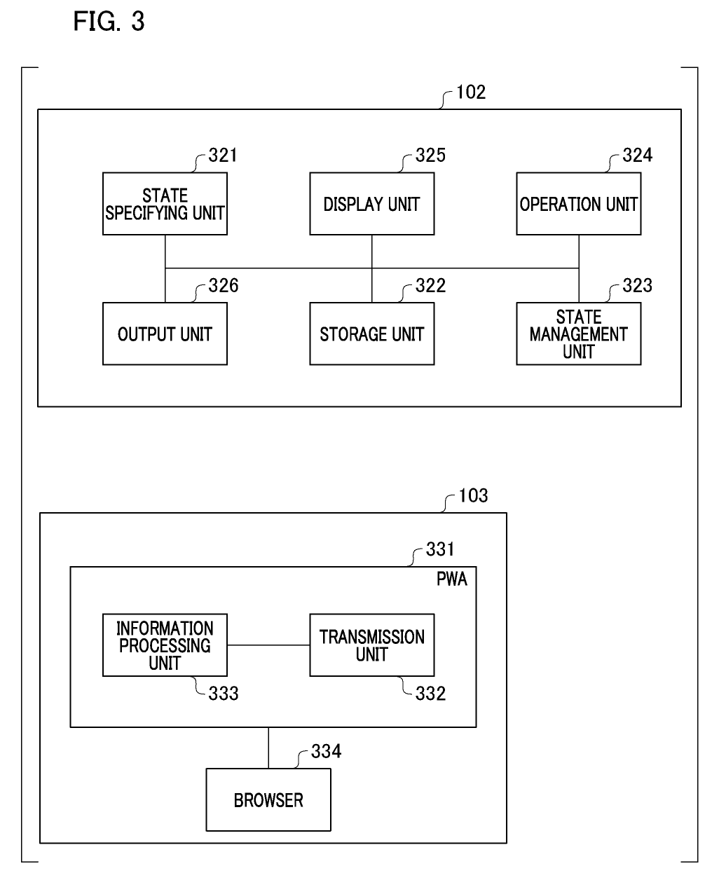

FIG. 3 is a diagram showing a functional configuration of the printer 102 and a functional configuration of the information terminal 103.

The printer 102 includes a state specifying unit 321, a storage unit 322, a state management unit 323, an operation unit 324, a display unit 325, and an output unit 326.

The state specifying unit 321 serving as an example of a calculation unit specifies a state of the printer 102. The state specifying unit 321 calculates an index indicating the state of the printer 102 based on event information indicating an event that occurred in the printer 102, various counter information of the printer 102, consumption level information indicating a consumed level of consumable parts provided in the printer 102, and the like. Indices calculated by the state specifying unit 321 include, for example, an index indicating a usage status of the printer 102, an index indicating an operation status of the printer 102, and the like. In addition, examples of the index indicating the usage status of the printer 102 and the index indicating the operation status of the printer 102 include indices such as power consumption of the printer 102, an index of environmental performance of the printer 102, presence or absence of occurrence of trouble in the printer 102, and the like. It should be noted that identification information (serial number) identifying the printer 102, network information (IP address) of the printer 102, and the like may be used for calculation of the index by the state specifying unit 321.

The storage unit 322 stores information. The information stored in the storage unit 322 includes information necessary for management of the printer 102. Examples of the information necessary for management of the printer 102 include firmware information, information such as an identification number of the printer 102, various counter information, consumption level information of consumable parts, information indicating presence or absence of an abnormality of the printer 102, information indicating a history of the printer 102, and the like. In addition, examples of the information indicating the history of the printer 102 include information indicating an operation history of the printer 102, information indicating a history of an abnormality that occurred in the printer 102, and the like. In addition, the storage unit 322 may store information related to the information terminal 103 that is a target of transmission of information by the printer 102, and the like.

The state management unit 323 manages the state of the printer 102, such as an operation state, an abnormal state, and the like of the printer 102. In addition, the state management unit 323 manages counter information. The counter information includes, for example, a value counted by a sensor (not shown) as the number of sheets printed in the printer 102, consumption level information indicating the extent of consumption of parts and consumables, and the like. Information managed by the state management unit 323 is stored in the storage unit 322.

The operation unit 324 is an interface that receives a user operation with respect to the printer 102.

The display unit 325 displays information indicating the state of the printer 102. The information indicating the state of the printer 102 includes consumption level information such as information indicating a remaining toner amount, information indicating settings in the printer 102, an index calculated by the state specifying unit 321, and the like.

The output unit 326 serving as an example of an output unit outputs information such as an index calculated by the state specifying unit 321 to the information terminal 103.

In the present embodiment, the above-described functions of each functional unit of the printer 102 are realized by the CPU 231 of the printer 102 executing a program stored in the printer 102.

The information terminal 103 has a PWA 331 and a browser 334.

The browser 334 displays a remote UI. The PWA 331 is installed via the remote UI.

A transmission unit 332 and an information processing unit 333 are included in the PWA 331.

The transmission unit 332 transmits, to the printer 102, information such as settings in the PWA 331 for provision of information from the printer 102 to the information terminal 103.

The information processing unit 333 acquires information transmitted from the printer 102, and outputs the acquired information to the output device 206.

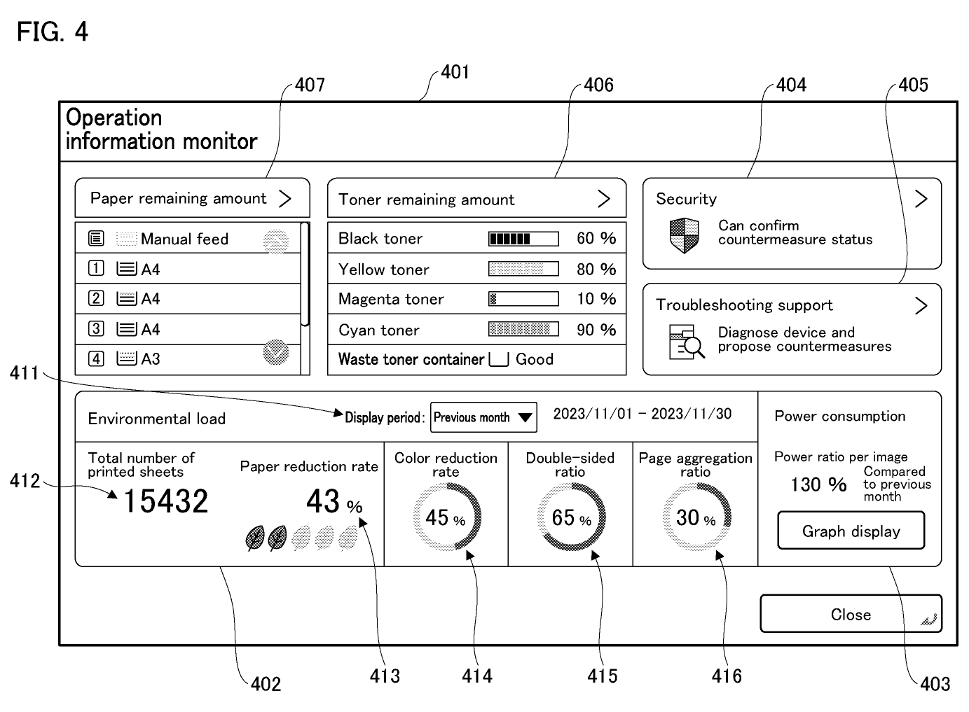

FIG. 4 is a diagram showing a state monitoring screen 401. The state monitoring screen 401 is a screen used for monitoring of the state of the printer 102. The state monitoring screen 401 is displayed on the display unit 325 of the printer 102.

On the state monitoring screen 401, a usage information unit 402, a power information unit 403, a security index unit 404, an abnormality index unit 405, a toner information unit 406, and a paper information unit 407 are displayed, like a dashboard, so as to improve at-a-glance visibility.

In the usage information unit 402, information indicating a status of usage of the printer 102 is shown. In the usage information unit 402, a period reception unit 411, a sheet count information unit 412, a paper index unit 413, a color reduction information unit 414, a duplex index unit 415, and an aggregate index unit 416 are shown.

The period reception unit 411 receives a setting of a target period for which information is displayed in the usage information unit 402. In the present embodiment, selection of a period by the user is possible in the period reception unit 411, and information related to the usage status of the printer 102 in the selected period is displayed in the usage information unit 402. In the example shown in the drawing, November is selected in the period reception unit 411 as the target period for which information is displayed in the usage information unit 402. It should be noted that the target period that is selected in the period reception unit 411 and for which information is displayed in the usage information unit 402 may hereinafter be referred to as the target period.

In the sheet count information unit 412, the number of sheets printed by the printer 102 in the target period is shown. In the example shown in the drawing, the text “15432” is shown in the sheet count information unit 412.

In the paper index unit 413, an index related to the number of printed sheets of the printer 102 in the target period is shown. More specifically, in the paper index unit 413, a ratio of the number of printed sheets of the printer 102 in the target period with respect to the month before the target period is shown. In the example shown in the drawing, in the paper index unit 413, the text “43%” meaning that the number of printed sheets in the target period decreased with respect to the month before the target period is shown.

In the reduction information unit 414, an index related to the number of color printed sheets of the printer 102 in the target period is shown. More specifically, in the color reduction information unit 414, a ratio of the number of color printed sheets of the printer 102 in the target period with respect to the month before the target period is shown. In the example shown in the drawing, in the color reduction information unit 414, the text “45%” meaning that the number of color printed sheets in the target period decreased with respect to the month before the target period is shown.

In the duplex index unit 415, an index related to duplex printing of the printer 102 in the target period is shown. More specifically, in the duplex index unit 415, a reduction rate of paper by duplex printing of the printer 102 in the target period with respect to the month before the target period is shown. In the example shown in the drawing, in the duplex index unit 415, the text “65%” that is the reduction rate of paper by duplex printing of the target period with respect to the month before the target period is shown.

In the aggregate index unit 416, an index related to consolidated printing of the printer 102 in the target period is shown. More specifically, in the aggregate index unit 416, a reduction rate of paper by aggregate printing of the printer 102 in the target period with respect to the month before the target period is shown. In the example shown in the drawing, in the aggregate index unit 416, the text “30%” that is the reduction rate of paper by aggregate printing of the target period with respect to the month before the target period is shown.

In the power information unit 403, an index related to power consumption of the printer 102 in the target period is shown. More specifically, in the power information unit 403, a ratio of power consumption of the printer 102 in the target period with respect to the month before the target period is shown. In the illustrated example, in the power information unit 403, text “130%” meaning that power consumption of the printer 102 in the target period has increased with respect to the month before the target period is shown.

In the security index unit 404, an index related to security in the printer 102 is shown. More specifically, in the security index unit 404, information indicating whether or not the printer 102 is connectable to the network 101 normally, security measures not implemented in the printer 102, and the like are shown. The information shown in the security index unit 404 is an index specified by the state specifying unit 321 from information stored in the storage unit 322, such as information indicating a connection status of the network of the printer 102 and information indicating an implementation status of security measures in the printer 102, and the like.

In the abnormality index unit 405, an index related to abnormalities in the printer 102 is shown. More specifically, in the abnormality index unit 405, in a case in which an abnormality is occurring in the printer 102, content of the abnormality that is occurring and a recommended measure for responding to the abnormality that is occurring are shown.

The information shown in the period reception unit 411, the sheet count information unit 412, the paper index unit 413, the color reduction information unit 414, the duplex index unit 415, the aggregate index unit 416, the power information unit 403, the security index unit 404, and the abnormality index unit 405 represents indices specified by the state specifying unit 321.

In the toner information unit 406, the remaining amount of toner for each toner in the printer 102 is shown.

In the paper information unit 407, a remaining amount of paper in the printer 102 is shown for each tray.

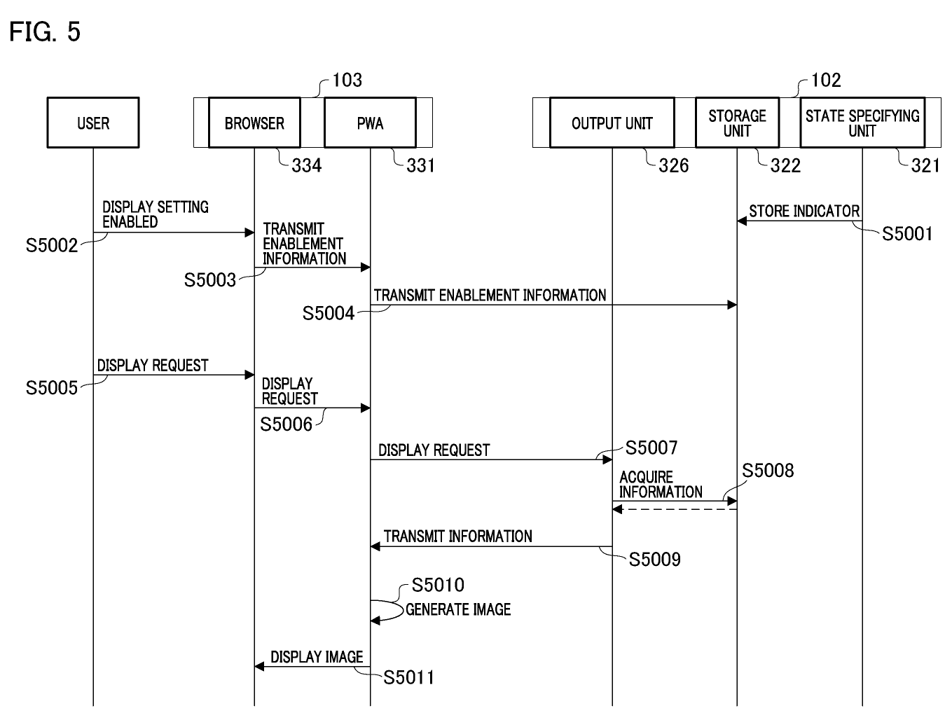

FIG. 5 is a sequence diagram showing a flow from when the printer 102 specifies a state until information indicating the specified state is displayed on the information terminal 103.

First, the state specifying unit 321 of the printer 102 calculates an index indicating the state of the printer 102, and causes the calculated index to be stored in the storage unit 322 (step (hereinafter may be referred to as “S”) 5001). The processing of step 5001 is performed every predetermined time. In this manner, in the printer 102, each time the latest information such as event information, various counter information, consumption level information, and the like is acquired, the state of the printer 102 is specified based on the latest information.

Next, by operating the information terminal 103, the user enables, in the browser 334, a setting for display on the output device 206 of information with respect to the state of the printer 102 (S5002).

The browser 334 transmits, to the PWA 331, enablement information indicating that the setting for display of information with respect to the state of the printer 102 to the output device 206 has been enabled (S5003).

The PWA 331 transmits, to the printer 102, the enablement information and identification information of the information terminal 103 (S5004). The enablement information and identification information transmitted from the PWA 331 are stored in the storage unit 322 of the printer 102.

Next, the user operates the information terminal 103 to request, in the browser 334, that information related to the printer 102 be displayed on the output device 206 (S5005). Examples of the request include a request for display of information related to the printer 102 in a case in which information related to the printer 102 is not displayed on the output device 206, a request for update of information related to the printer 102 displayed on the output device 206, and the like.

The browser 334 notifies the PWA 331 of the request for display received in step 5005 (S5006).

The PWA 331 notifies the output unit 326 of the printer 102 of the request for display received in step 5006 and of identification information of the information terminal 103 (S5007).

The output unit 326 of the printer 102 acquires information that is stored in the storage unit 322 as information to be displayed on the output device 206 of the information terminal 103

(S5008). At this time, the information acquired by the output unit 326 also includes the index calculated by the state specifying unit 321.

The output unit 326 transmits the information acquired in step 5008 to the PWA 331 of the information terminal 103 (S5009).

When the PWA 331 acquires the information transmitted from the output unit 326, the PWA 331 generates an image to be displayed on the output device 206 based on the acquired information (S5010).

The PWA 331 causes the image generated in step 5010 to be displayed as a remote UI on the output device 206 via the browser 334 (S5011).

It should be noted that, in a state in which a setting for display on the output device 206 of information related to the state of the printer 102 is disabled, there may be cases in which display of information related to the printer 102 on the output device 206 is requested (refer to S5005). In this case, the PWA 331 causes information acquired in advance from the printer 102 to be displayed on the output device 206 via the browser 334 without requesting information from the printer 102. Even in this case, processing of step 5006 and processing of step 5007 is performed, and transmission processing described below is performed.

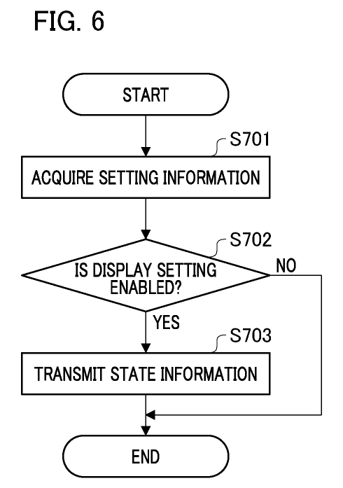

FIG. 6 is a flowchart diagram showing the flow of transmission processing. The transmission processing is processing in which the output unit 326 of the printer 102 transmits information related to the printer 102 to the information terminal 103. In the present embodiment, when the printer 102 receives a request for display of information related to the printer 102 (refer to S5007 of FIG. 5) from the information terminal 103, the transmission processing is started.

The output unit 326 acquires, from the storage unit 322, information indicating whether or not the setting for display on the information terminal 103 of information related to the state of the printer 102 is enabled (S701). Additionally, in a case in which enablement information has not been transmitted from the information terminal 103 to the printer 102, information indicating that the setting for display on the information terminal 103 of information related to the state of the printer 102 is disabled is stored in the storage unit 322. In addition, the information acquired in step 701 is information for the information terminal 103 specified from the identification information acquired by the output unit 326 as a trigger for start of the transmission processing.

The output unit 326 determines, based on the information acquired in step 701, whether or not a setting for display on the information terminal 103 of information related to the state of the printer 102 is enabled (S702).

In a case in which a setting for display on the information terminal 103 of information related to the state of the printer 102 is disabled (NO in S702), the transmission processing ends. In this case, in the transmission processing, the output unit 326 does not transmit information related to a state of the printer 102 to the information terminal 103.

In addition, in a case in which the setting for display on the information terminal 103 of information related to the state of the printer 102 is enabled (YES in S702), processing proceeds to the next step. The output unit 326 acquires information related to the state of the printer 102 from the storage unit 322, and transmits the acquired information to the information terminal 103 (S703). The processing of step S703 of the transmission processing is the same processing as processing of step 5008 and processing of step 5009 shown in FIG. 5.

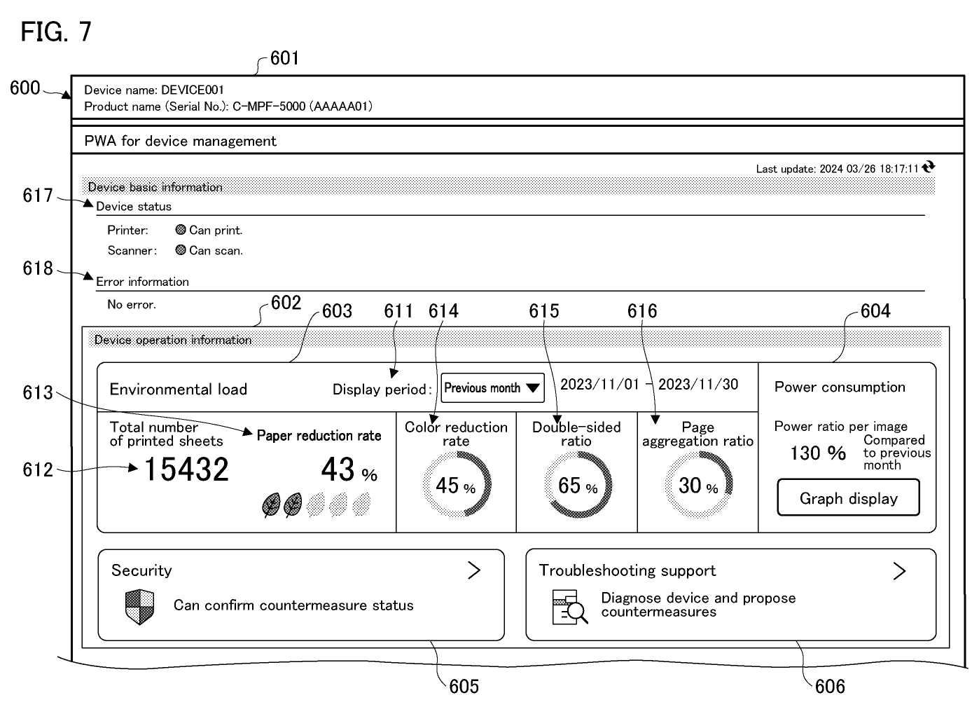

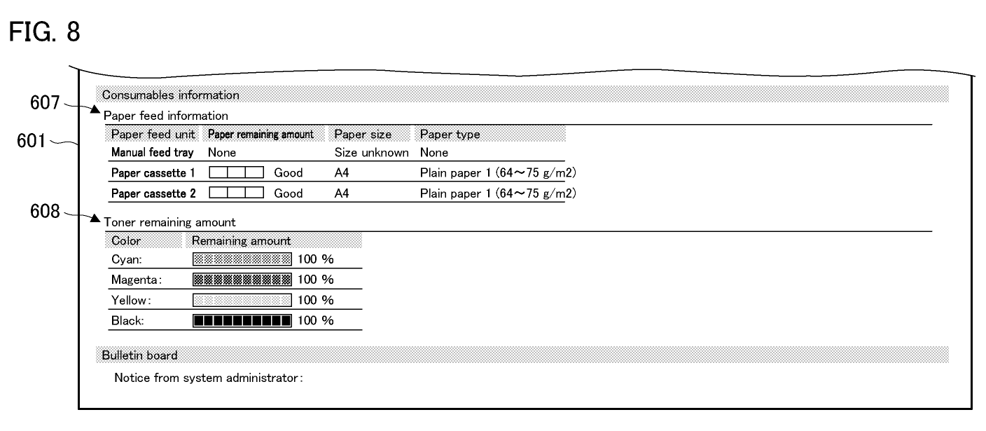

FIG. 7 and FIG. 8 are diagrams showing a state screen 601. The state screen 601 is a screen on which information related to the state of the printer 102 is shown. In the present embodiment, when the output unit 326 of the printer 102 transmits information related to a state of the printer 102 in the transmission processing (see S703 of FIG. 6), the state screen 601 is displayed on the output device 206 of the information terminal 103. At this time, the information terminal 103 on which the state screen 601 is displayed is the information terminal 103 that requested display of information related to the printer 102.

In the state screen 601, an identification unit 600, an operation information unit 617, an error information unit 618, a state image 602, a paper feed information unit 607, and a toner remaining amount unit 608 are shown.

The identification unit 600 indicates information identifying the printer 102.

In the operation information unit 617, information related to operation of the printer 102 is shown. In the illustrated example, in the operation information unit 617, availability of the print operation in the printer 102 and availability of the scan operation in the printer 102 are shown.

In the error information unit 618, presence or absence of an error that is currently occurring in the printer 102 is shown. In the illustrated example, it is shown in the error information unit 618 that no error is currently occurring in the printer 102.

In the state image 602, information related to the state of the printer 102 is shown. In the state image 602, a usage information unit 603, a power information unit 604, a security index unit 605, and an abnormality index unit 606 are shown.

In the usage information unit 603, information indicating a usage status of the printer 102 is shown. In the usage information unit 603, a period reception unit 611, a sheet count information unit 612, a paper index unit 613, a color reduction information unit 614, a duplex index unit 615, and an aggregate index unit 616 are shown. The period reception unit 611 is the same image as the period reception unit 411 in the state monitoring screen 401, and the sheet count information unit 612 is the same image as the sheet count information unit 412 in the state monitoring screen 401. In addition, the paper index unit 613 is the same image as the paper index unit 413 in the state monitoring screen 401, the color reduction information unit 614 is the same image as the color reduction information unit 414 in the state monitoring screen 401, the duplex index unit 615 is the same image as the duplex index unit 415 in the state monitoring screen 401, and the aggregate index unit 616 is the same image as the aggregate index unit 416 in the state monitoring screen 401.

In addition, the power information unit 604 is the same image as the power information unit 403 in the state monitoring screen 401, the security index unit 605 is the same image as the security index unit 404 in the state monitoring screen 401, and the abnormality index unit 606 is the same image as the abnormality index unit 405 in the state monitoring screen 401.

In the paper feed information unit 607, information related to paper feed in the printer 102 is shown. More specifically, in the paper feed information unit 607, the remaining amount of paper, the size of paper, and the type of paper in the printer 102 are shown for each of a plurality of trays provided in the printer 102.

In the toner remaining amount unit 608, the remaining amount of toner for each toner in the printer 102 is shown.

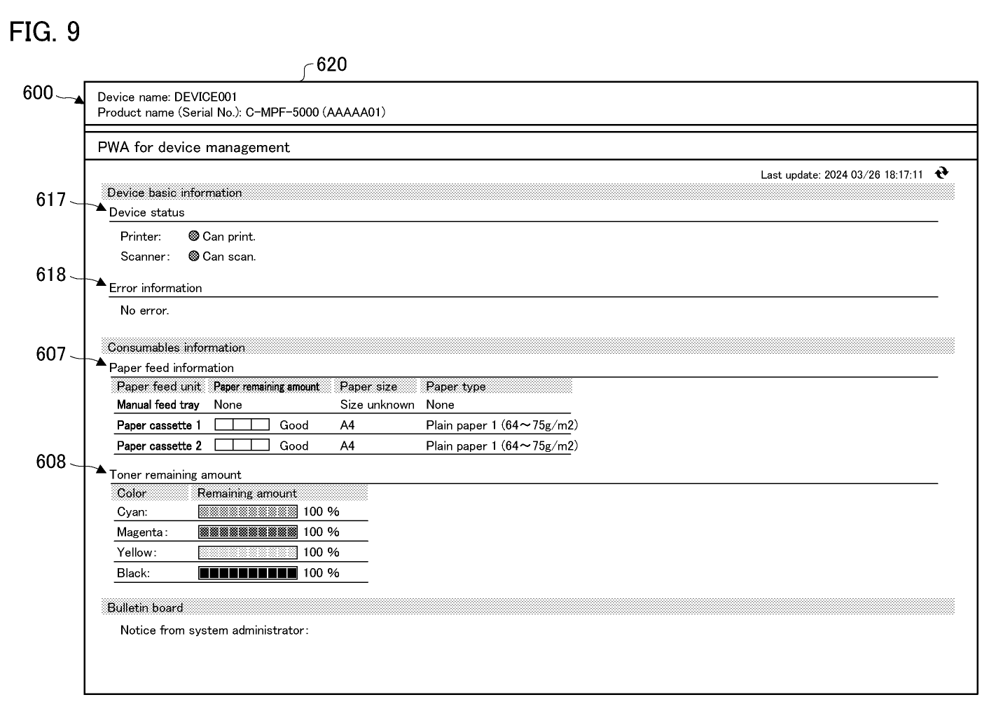

FIG. 9 is a diagram showing a printer information screen 620. The printer information screen 620 is a screen on which information related to the printer 102 is shown. In the present embodiment, the printer information screen 620 is a screen that is displayed on the information terminal 103 in a case in which a setting for display on the information terminal 103 of information related to a state of the printer 102 is disabled.

In the printer information screen 620, the identification unit 600, the operation information unit 617, the error information unit 618, the paper feed information unit 607, and the toner remaining amount unit 608 are shown. That is, on the printer information screen 620, the same images as images of a part of the state screen 601 (refer to FIG. 7 and FIG. 8) are displayed. In contrast, on the printer information screen 620, the state image 602 is not displayed.

For example, at each predetermined time interval, the printer 102 notifies the information terminal 103 of latest information related to paper feed in the printer 102, the latest remaining amount of toner, latest information related to operation of the printer 102, and presence or absence of an error that is currently occurring in the printer 102. In this manner, even in a case in which information provision from the printer 102 to the information terminal 103 is not performed when display on the output device 206 of information related to the printer 102 is requested (refer to S5005 of FIG. 5), information related to the printer 102 is displayed on the information terminal 103.

In this manner, the output unit 326 of the printer 102 outputs an information image including information of the printer 102 itself to the information terminal 103 on which software serving as the PWA 331 for providing information of the printer 102 itself is installed. Examples of the information image include the state screen 601, the printer information screen 620, and the like. In addition, examples of the information of the printer 102 itself include information shown in the identification unit 600, the operation information unit 617, the error information unit 618, the state image 602, the paper feed information unit 607, the toner remaining amount unit 608, and the like. In addition, the information of the printer 102 itself can also be regarded as device information related to a network device. In addition, the step performed by the output unit 326 can also be regarded as an output step of outputting an information image including the device information to the information terminal 103.

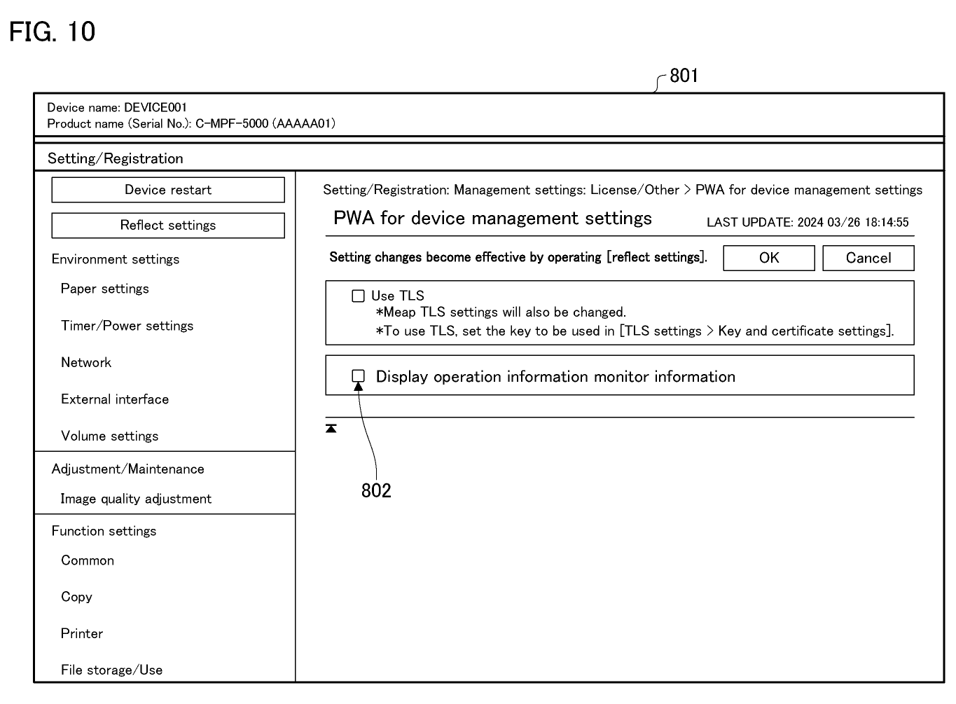

FIG. 10 is a diagram showing a setting screen 801. The setting screen 801 is a screen that receives a setting for display on the information terminal 103 of information related to the state of the printer 102. The setting screen 801 is displayed on the output device 206 by the browser 334 of the information terminal 103 on which the PWA 331 is installed.

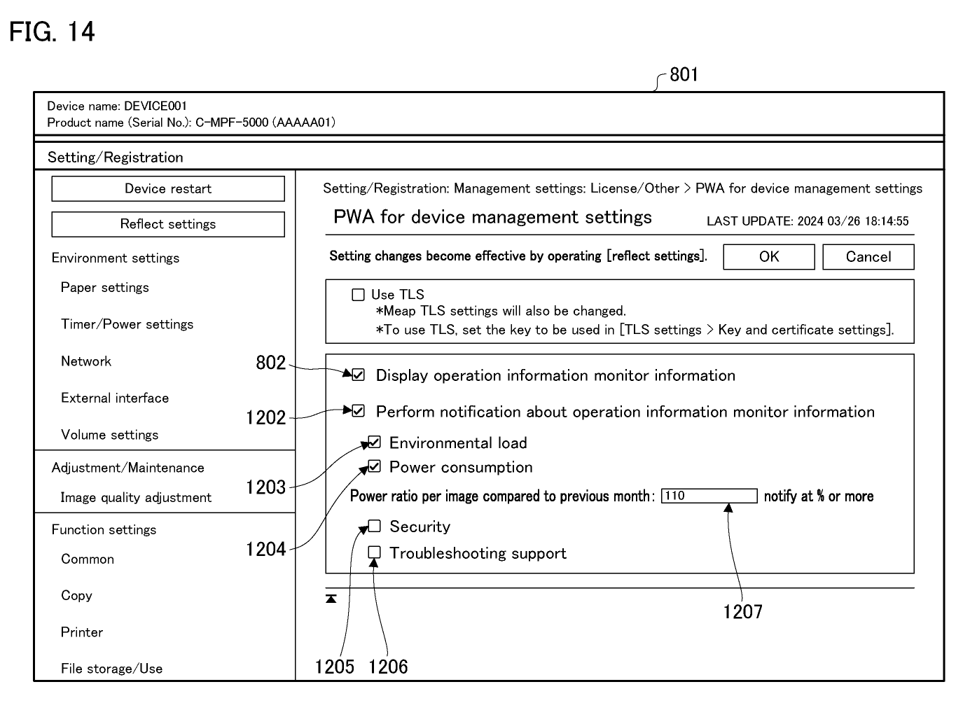

In the setting screen 801, an enablement reception unit 802 is shown. The enablement reception unit 802 receives enablement of a setting for display on the information terminal 103 of information related to the state of the printer 102. When the user selects the enablement reception unit 802 by operating the information terminal 103, the setting of display on the information terminal 103 of information related to the state of the printer 102 becomes enabled (refer to S5002 of FIG. 5). It should be noted that the setting screen 801, the enablement reception unit 802, and the like can also be provided by using the remote UI before the PWA 331 is installed on the information terminal 103. Thereby, before the PWA 331 is distributed, the administrator of the printer 102 can enable use of the PWA 331 for a user of the printer 102. Information indicating that the setting is enabled is stored in the storage unit 322 of the printer 102. An additional setting shown in FIG. 14 described below can also be provided by using the remote UI.

In the present embodiment, in a case in which the information terminal 103 requests display on the output device 206 of information related to the printer 102 in a state in which the enablement reception unit 802 is selected (refer to S5005 of FIG. 5), the state screen 601 (refer to FIG. 7 and FIG. 8) is displayed on the information terminal 103. Stated differently, in a case in which transmission processing (refer to FIG. 6) is executed in a state in which the enablement reception unit 802 is selected, the state screen 601 is displayed on the information terminal 103.

In addition, in a case in which the information terminal 103 requests display on the output device 206 of information related to the printer 102, in a state in which the enablement reception unit 802 is not selected, the printer information screen 620 (refer to FIG. 9) is displayed on the information terminal 103. Stated differently, in a case in which transmission processing is executed in a state in which the enablement reception unit 802 is not selected, the printer information screen 620 is displayed on the information terminal 103.

### Second Embodiment

Next, the management system 100 of the Second Embodiment is explained. The management system 100 of the Second Embodiment, in addition to providing information related to a state of the printer 102 to the information terminal 103 on which a PWA is installed, performs push notification in a case in which the printer 102 is in a predetermined state.

It should be noted that, with respect to the management system 100 of the Second Embodiment, a configuration that is different from the First Embodiment is explained, and an explanation of a configuration that is the same as the First Embodiment is omitted.

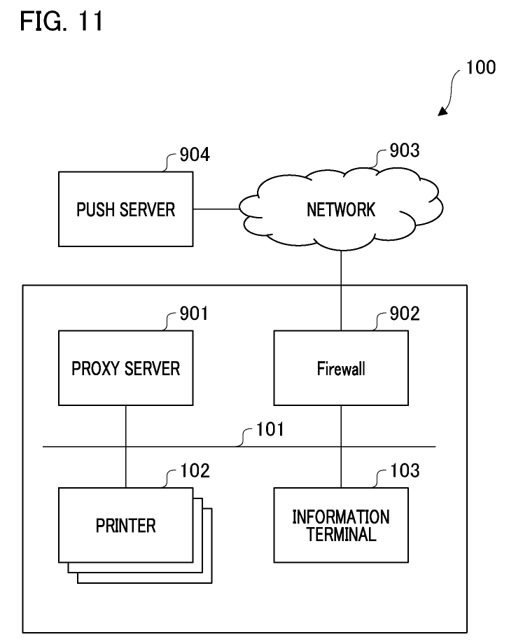

FIG. 11 is an overall configuration diagram of the management system 100 of the present embodiment.

The management system 100 includes the printer 102, the information terminal 103, a proxy server 901, a firewall 902, and a push server 904. The printer 102, the information terminal 103, the proxy server 901, and the firewall 902 are each connected via the network 101. In addition, the printer 102, the information terminal 103, the proxy server 901, and the firewall 902 are connected to the push server 904 via a network 903.

The firewall 902 is provided in order to increase the security of the network 101 and security of the network 903.

The push server 904 is a server apparatus provided for a browser vendor to provide a push service using a PWA. Push notification from the printer 102 to the information terminal 103 is realized via the push server 904.

The type of the network 903 is not particularly limited provided that transmission and reception of data are possible. The network 903 includes, for example, the Internet, a LAN (Local Area Network), a WAN (Wide Area Network), a telephone line, a dedicated digital line, an ATM or frame relay line, a cable television line, a wireless line for data broadcasting, and the like. In addition, a communication line used for transmission and reception of data may be wired or wireless.

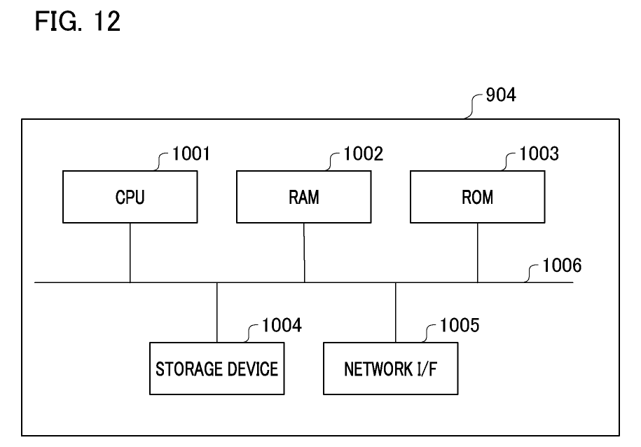

FIG. 12 is a hardware configuration diagram of the push server 904.

The push server 904 includes a CPU 1001, a RAM 1002, a ROM 1003, a storage device 1004, and a network I/F 1005. The CPU 1001, the RAM 1002, the ROM 1003, the storage device 1004, and the network I/F 1005 are each connected via an internal bus 1006.

The CPU 1001 controls the entirety of the push server 904 by executing a program stored in the ROM 1003. In addition, the CPU 1001, the RAM 1002, and the ROM 1003 perform execution processing of the program. In addition, the CPU 1001 records an image on a recording medium such as the storage device 1004. The network I/F 1005 connects to external apparatuses such as the printer 102 and the information terminal 103 via the network 903.

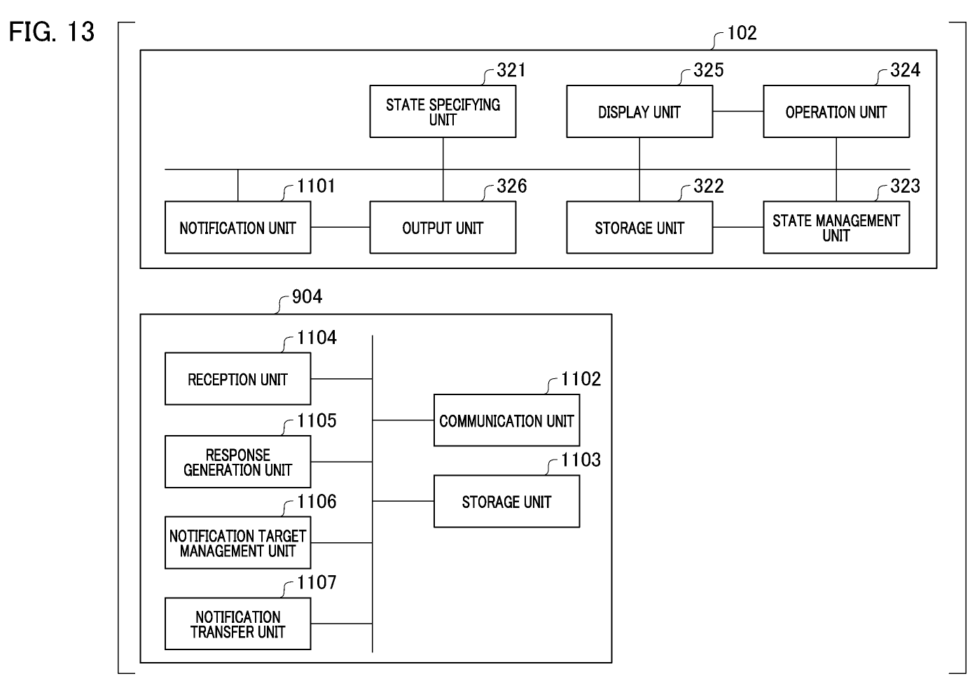

FIG. 13 is a diagram showing a functional configuration of the printer 102 and a functional configuration of the push server 904. It should be noted that, since the functional configuration of the information terminal 103 is the same as that of the First Embodiment, an explanation thereof is omitted.

The printer 102 includes the state specifying unit 321, the storage unit 322, the state management unit 323, the operation unit 324, the display unit 325, the output unit 326, and a notification unit 1101.

The output unit 326 determines whether or not an execution condition of push notification from the printer 102 to the information terminal 103 is satisfied. Then, in a case in which the output unit 326 determines that the execution condition of the push notification is satisfied, the output unit 326 requests a push notification from the notification unit 1101.

The notification unit 1101 serving as an example of a notification unit is an application server that performs push notification to the information terminal 103. When the notification unit 1101 receives a request for the push notification from the output unit 326, the notification unit 1101 transmits the request for the push notification, together with information indicating content of the push notification and identification information of the information terminal 103 that is a target of the push notification, to the push server 904. The content of the push notification transmitted by the notification unit 1101 includes, for example, content related to the state of the printer 102. In addition, content related to the state of the printer 102 includes, for example, power consumption of the printer 102, an increase in environmental load, a security alert, and the like.

The push server 904 includes a communication unit 1102, a storage unit 1103, a reception unit 1104, a response generation unit 1105, a notification target management unit 1106, and a notification transfer unit 1107.

The communication unit 1102 communicates with external apparatuses such as the printer 102 and the information terminal 103, and receives a request for push notification from the printer 102, and transmits the push notification to the information terminal 103.

The storage unit 1103 stores information. Examples of information stored in the storage unit 1103 include information of the information terminal 103 registered as a target of the push notification, information indicating a request for the push notification, and the like.

The reception unit 1104 receives a request for registration of the information terminal 103 as a target of the push notification, transmitted from the browser 334 of the information terminal 103. In addition, the reception unit 1104 receives a request for the push notification from the notification unit 1101 of the printer 102.

The response generation unit 1105 responds to the request for registration of the information terminal 103 as the target of the push notification. More specifically, the response generation unit 1105 generates a Push Subscription object, and transmits the generated Push Subscription object to the browser 334 of the information terminal 103 that made the request.

The notification target management unit 1106 registers the information terminal 103 for which the request for registration as the target of the push notification was made, as the target of the push notification, and manages the information terminal 103 as the target of the push notification. The notification target management unit 1106 manages identification information of the information terminal 103 as the target of the push notification and the Push Subscription object.

The notification transfer unit 1107, based on endpoint information included in the request for the push notification from the notification unit 1101 of the printer 102, transfers the requested push notification to the information terminal 103 that is the target of the push notification.

FIG. 14 is a diagram showing the setting screen 801 of the present embodiment. In the present embodiment, the setting screen 801 shown in FIG. 14 is displayed on the output device 206 of the information terminal 103 registered in the push server 904 as the target of the push notification.

In the setting screen 801 shown in FIG. 14, the enablement reception unit 802 and a notification reception unit 1202 are shown.

The notification reception unit 1202 receives enablement of a setting of push notification from the printer 102 to the information terminal 103. When the user selects the notification reception unit 1202 by operating the information terminal 103, the setting of the push notification from the printer 102 to the information terminal 103 becomes enabled.

In addition, in the setting screen 801, an environment notification reception unit 1203, a power notification reception unit 1204, a threshold reception unit 1207, a security notification reception unit 1205, and an abnormality notification reception unit 1206 are shown.

The environment notification reception unit 1203 receives enablement of a setting of push notification related to environmental performance of the printer 102. When the user selects the environment notification reception unit 1203 by operating the information terminal 103, the setting of the push notification related to the environmental performance of the printer 102 becomes enabled. In addition, in a state in which the notification reception unit 1202 and the environment notification reception unit 1203 are selected, when the environmental performance of the printer 102 becomes a predetermined state, the notification unit 1101 of the printer 102 performs push notification to the information terminal 103 via the push server 904.

The power notification reception unit 1204 receives enablement of a setting of push notification related to power consumption of the printer 102. When the user selects the power notification reception unit 1204 by operating the information terminal 103, the setting of the push notification related to power consumption of the printer 102 becomes enabled.

The threshold reception unit 1207 receives an input of a threshold of power consumption that is a target of push notification. In the example shown in the drawing, the threshold reception unit 1207 receives an input as a threshold of a ratio of power consumption in the printer 102 of this month with respect to the previous month. In addition, in the example shown in the drawing, “110” is input to the threshold reception unit 1207. Then, in a state in which the notification reception unit 1202 and the power notification reception unit 1204 are selected, when the ratio of power consumption in the printer 102 of this month with respect to the previous month becomes 110% or more, the notification unit 1101 performs push notification to the information terminal 103 via the push server 904. A state in which the printer 102 corresponds to the index input to the threshold reception unit 1207 is an example of a predetermined state with respect to the power consumption of the printer 102.

The security notification reception unit 1205 receives enablement of a setting of push notification related to a state of security in the printer 102. When the user selects the security notification reception unit 1205 by operating the information terminal 103, the setting of the push notification related to the state of security of the printer 102 becomes enabled. In addition, in a state in which the notification reception unit 1202 and the security notification reception unit 1205 are selected, when the state of security of the printer 102 becomes a predetermined state, the notification unit 1101 performs push notification to the information terminal 103 via the push server 904.

The abnormality notification reception unit 1206 receives enablement of a setting of push notification related to a state of abnormality in the printer 102. When the user selects the abnormality notification reception unit 1206 by operating the information terminal 103, the setting of the push notification related to the state of abnormality of the printer 102 becomes enabled. In addition, in a state in which the notification reception unit 1202 and the abnormality notification reception unit 1206 are selected, when the state of abnormality of the printer 102 becomes a predetermined state, the notification unit 1101 performs push notification to the information terminal 103 via the push server 904.

It should be noted that the environment notification reception unit 1203, the power notification reception unit 1204, the threshold reception unit 1207, the security notification reception unit 1205, and the abnormality notification reception unit 1206 are operable only in a case in which the notification reception unit 1202 is selected.

The output unit 326 of the printer 102, in a state in which the notification reception unit 1202 is selected, focuses on an item for which a setting is enabled among the environment notification reception unit 1203, the power notification reception unit 1204, the security notification reception unit 1205, and the abnormality notification reception unit 1206. Then, the output unit 326 determines, with respect to the focused item, whether or not the printer 102 is in a state satisfying an execution condition of push notification based on the latest index calculated by the state specifying unit 321, and in a case in which the execution condition is satisfied, requests push notification. That is, the state of the printer 102 satisfying the execution condition of push notification is a state in which the index calculated by the state specifying unit 321 satisfies the execution condition of push notification.

It should be noted that, with respect to an item among the environment notification reception unit 1203, the power notification reception unit 1204, the security notification reception unit 1205, and the abnormality notification reception unit 1206 for which a setting is disabled, push notification is not performed even in a state in which the execution condition of push notification is satisfied. In addition, in a case in which the notification reception unit 1202 is not selected, push notification is not performed even in a state in which the execution condition of push notification is satisfied with respect to any item.

In addition, an item that receives an input of a threshold of an index indicating the state of the printer 102 that is a target of push notification is not limited to the power consumption of the printer 102.

Also with respect to the environment notification reception unit 1203, the security notification reception unit 1205, and the abnormality notification reception unit 1206, similarly to the threshold reception unit 1207, an image that receives an input of a threshold of an index indicating the state of the printer 102 that is a target of push notification may be displayed.

In addition, an item for which a state determined with respect to a relationship with a past state of the printer 102 is determined as the execution condition of push notification is not limited to the power consumption of the printer 102.

Also with respect to the environmental performance of the printer 102, the state of security in the printer 102, and the state of abnormality in the printer 102, a state determined with respect to a relationship with a past state may be determined as the execution condition for push notification.

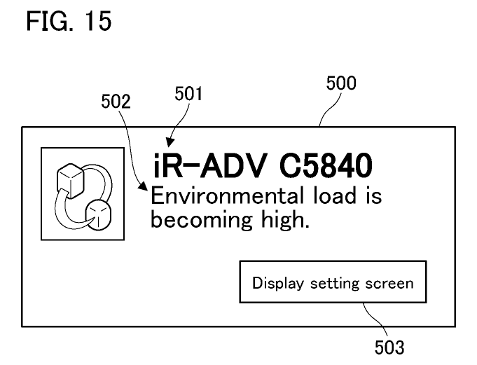

FIG. 15 is a diagram showing a notification screen 500. The notification screen 500 is an image indicating content of push notification from the printer 102. In the present embodiment, by the printer 102 performing push notification via the push server 904, the notification screen 500 is displayed on the output device 206 of the information terminal 103.

On the notification screen 500, an identification unit 501, a notification unit 502, and a reception unit 503 are shown.

In the identification unit 501, information identifying the printer 102 that is the destination of the push notification is shown.

In the notification unit 502, content of the push notification is shown. In the example shown in the drawing, in the notification unit 502, text of “Environmental load is high.” related to the environmental performance of the printer 102 is shown.

The reception unit 503 receives display on the information terminal 103 of information related to the printer 102. In a case in which the reception unit 503 is selected, in a case in which the setting for display on the output device 206 of information related to the state of the printer 102 is enabled, the state screen 601 (refer to FIG. 7 and FIG. 8) is displayed on the information terminal 103. In addition, in a case in which the reception unit 503 is selected, in a case in which the setting for display on the output device 206 of information related to the state of the printer 102 is disabled, the printer information screen 620 (refer to FIG. 9) is displayed on the information terminal 103.

In this manner, in a case in which the printer 102 performs push notification to the information terminal 103, omission of confirmation by the user of information related to the printer 102 is suppressed. In particular, even in a case in which the user cannot immediately confirm states of all printers 102, such as a case in which a plurality of printers 102 are provided in the management system 100, the state of the printer 102 that became a target of push notification is recognized by the user quickly.

As described above, the display unit of the printer 102 displays, on the display unit 325, a display screen provided by a dashboard for providing at least one of information indicating a countermeasure status of security of the printer 102 itself, information related to troubleshooting of the printer 102 itself, and information related to environmental load. An example of the display unit is the CPU 231 of the printer 102. In addition, the storage unit of the printer 102 stores a setting indicating that information provided by the dashboard is also provided by software utilizing a Progressive Web App. An example of the storage unit is the storage unit 322. Then, the output unit of the printer 102 outputs, in accordance with the setting, data including the information provided by the dashboard to the information terminal 103 on which the software utilizing the Progressive Web App is installed via a remote user interface. An example of the output unit is the output unit 326.

In this case, the burden on the user in confirming information related to the state of the printer 102 is reduced as compared to a configuration in which information related to the state of the printer 102 is displayed only on the printer 102.

In addition, the printer 102 further includes a notification unit that causes the information terminal 103 on which software using the Progressive Web App has been installed to issue a push notification for the user, in a case in which the printer 102 itself is in a predetermined state. An example of the notification unit is the notification unit 1101. In addition, an example of the predetermined state is the state of the printer 102 satisfying the execution condition of push notification described above.

In this case, even in a case in which the user is not performing an operation for causing information related to the state of the printer 102 to be displayed on the information terminal 103, the user is notified of information related to the printer 102.

In addition, the printer 102 further includes a providing unit that provides a reception screen that receives a setting of the predetermined state that is a target of push notification. An example of the providing unit is the output unit 326. In addition, an example of the reception screen is the setting screen 801 (refer to FIG. 14).

In this case, even in a case in which the user is not performing an operation for causing the information terminal 103 to display information related to the state of the printer 102, the user is notified of information related to the set state of the printer 102.

In addition, on the reception screen, input of an index corresponding to a predetermined state serving as a target of push notification is received (refer to the threshold reception unit 1207 in FIG. 14).

In this case, even in a case in which the user is not performing an operation for causing information related to the state of the printer 102 to be displayed on the information terminal 103, information corresponding to the input index and related to the state of the printer 102 is notified to the user.

In addition, the printer 102 further includes a calculation unit that calculates an index related to the state of the printer 102 itself based on operation information related to an operation of the printer 102 itself. Examples of the operation information include event information, counter information, consumption level information, and the like. Then, the notification unit of the printer 102 causes the information terminal 103 to issue a push notification for a user in a case in which the index calculated by the calculation unit is in a state of being a predetermined index. An example of the predetermined index is an index that satisfies the execution condition of push notification.

In this case, determination as to whether or not the printer 102 is in a predetermined state is simplified.

In addition, the predetermined state is a state determined with respect to a relationship with a past state of the printer 102.

In this case, even in a case in which the user is not performing an operation for causing the information terminal 103 to display information related to the state of the printer 102, information related to the state of the printer 102 determined with respect to the relationship with the past state of the printer 102 is notified to the user.

In addition, the information related to the state of the printer 102 includes first state information and second state information different from the first state information. Examples of the first state information include information shown in the paper feed information unit 607, the toner remaining amount unit 608, the operation information unit 617, and the error information unit 618. In addition, examples of the second state information include information shown in the sheet count information unit 612, the paper index unit 613, the color reduction information unit 614, the duplex index unit 615, the aggregate index unit 616, the power information unit 604, the security index unit 605, and the abnormality index unit 606. Then, the output unit 326 outputs an information image including the first state information and not including the second state information to the information terminal 103 in a case in which setting information is not acquired by the acquisition unit. In addition, the output unit 326 outputs an information image including the first state information and the second state information to the information terminal 103 in a case in which the setting information is acquired by the acquisition unit.

In this case, regardless of whether or not provision of the information related to the state of the printer 102 to the information terminal 103 is set, the burden on the user in confirming the state of the printer 102 is reduced. In addition, in a case in which the provision of the information related to the state of the printer 102 to the information terminal 103 is set, the burden on the user in confirming a more detailed state of the printer 102 is reduced.

### Other Embodiments

In addition, a case in which a program of software for realizing the functions of the above- described embodiments is supplied directly from a recording medium or by using wired communication or wireless communication to a system or an apparatus having a computer capable of executing the program, and the program is executed is also included in the present disclosure.

Accordingly, in order to realize, by the computer, the functional processing described above with respect to the present disclosure, program code itself supplied to and installed on the computer also realizes the present disclosure. That is, a computer program itself for realizing the functional processing of the present disclosure is also included in the present disclosure. In that case, as long as the program has the function of the program, the form of the program does not matter, such as object code, a program executed by an interpreter, script data supplied to an OS, and the like. Examples of a recording medium for supplying the program may include a magnetic recording medium such as a hard disk, a magnetic tape, and the like, an optical/magneto-optical storage medium, and a non-volatile semiconductor memory. In addition, as a method of supplying the program, a method in which a computer program forming the present disclosure is stored in a server on a computer network, and a connected client computer downloads the computer program and installs the computer program is also conceivable.

In addition, based on the instructions of the program code, an OS and the like operating on the computer may perform a part or all of actual processing, and each function of the above-described embodiments may be realized by the processing. Furthermore, the program code read out from the storage medium may be written to a memory provided in a function expansion board inserted into the computer or a function expansion unit connected to the computer. Then, based on the instructions of the program code, a CPU and the like provided in the function expansion board or the function expansion unit may perform part or all of the actual processing. Even in this case, each function of the above-described embodiments is realized.

Although the present disclosure has been described in detail above based on preferred embodiments thereof, the present disclosure is not limited to the above-described embodiments, and various modifications are possible based on the spirit of the present disclosure, and the various modifications are not excluded from the scope of the present disclosure.

According to the present disclosure, the burden on the user in confirming information related to the state of a network device can be reduced as compared to a configuration in which the information related to the state of the network device is displayed only on the network device.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-041322, filed Mar. 14, 2025, which is hereby incorporated by reference herein in its entirety.

What is claimed is:

1. A network device provided with a display unit, the network device being capable of providing a remote user interface to a user terminal via a web server, the network device comprising:
at least one memory storing instructions; and
at least one processor executing the stored instructions causing the network device to:
display, on the display unit, a display screen provided by a dashboard, the dashboard being configured to provide at least one of information indicating a security countermeasure status of the network device itself, information related to troubleshooting of the network device itself, and information related to environmental load;
store a setting indicating that the information provided by the dashboard is also to be provided by software using a Progressive Web App; and
in accordance with the setting, output, to the user terminal on which the software using the Progressive Web App has been installed via the remote user interface, data including the information provided by the dashboard.

2. The network device according to claim 1,
wherein executing the stored instructions by the processor further causes the network device to, in a case in which the network device itself is in a predetermined state, cause the user terminal on which the software using the Progressive Web App has been installed to issue a push notification for a user.

3. The network device according to claim 2,
wherein executing the stored instructions by the processor further causes the network device to provide a reception screen configured to receive a setting of the predetermined state, the predetermined state being a target of the push notification.

4. The network device according to claim 3,
wherein, on the reception screen, input of an index corresponding to the predetermined state is received, the predetermined state being a target of the push notification.

5. The network device according to claim 2,
wherein executing the stored instructions by the processor further causes the network device to calculate an index related to a state of the network device itself based on operation information related to an operation of the network device itself, and cause the user terminal to issue the push notification for the user in a case in which the calculated index is a predetermined index.

6. A control method of a network device provided with a display unit, the network device being capable of providing a remote user interface to a user terminal via a web server, the control method comprising:
displaying, on the display unit, a display screen provided by a dashboard, the dashboard being configured to provide at least one of information indicating a security countermeasure status of the network device, information related to troubleshooting of the network device, and information related to environmental load;
storing a setting indicating that the information provided by the dashboard is also to be provided by software using a Progressive Web App; and
outputting, in accordance with the setting, to the user terminal on which the software using the Progressive Web App has been installed via the remote user interface, data including the information provided by the dashboard.

7. A non-transitory storage medium storing a control program of a network device provided with a display unit, the network device being capable of providing a remote user interface to a user terminal via a web server, the control program causing a computer to perform each step of a control method of the network device, the method comprising:
displaying, on the display unit, a display screen provided by a dashboard, the dashboard being configured to provide at least one of information indicating a security countermeasure status of the network device, information related to troubleshooting of the network device, and information related to environmental load;
storing a setting indicating that the information provided by the dashboard is also to be provided by software using a Progressive Web App; and
outputting, in accordance with the setting, to the user terminal on which the software using the Progressive Web App has been installed via the remote user interface, data including the information provided by the dashboard.
